(19) United States
(12) Patent Application Publication
(10) Pub. No.: US 2022/0298851 A1
(43) Pub. Date: Sep. 22, 2022

(54) COMPOSITE FUNCTIONAL FILM INTERNAL WINDOW SYSTEM

(71) Applicant: Ichiro Wakao, Tokyo (JP)

(72) Inventor: Ichiro WAKAO, Tokyo (JP)

(21) Appl. No.: 17/837,049

(22) Filed: Jun. 10, 2022

Related U.S. Application Data
(63) Continuation-in-part of application No. PCT/JP2020/047785, filed on Dec. 21, 2020.

(30) Foreign Application Priority Data
Dec. 20, 2019 (JP) 2019-230362
Nov. 17, 2020 (JP) 2020-191007

(51) Int. Cl. E06B 9/24

(52) U.S. Cl. CPC E06B 9/24; E06B 2009/2417; E06B 2009/2447; E06B 2009/2476

(57) ABSTRACT

Provided is an internal window system, including: a plurality of sheet members having different functions; and a window frame body for laminating and holding the plurality of sheet members. The plurality of sheet members may have at least 2 different functions among light emission, light dimming, heat shielding, heat insulating, ultraviolet UV shielding, heat generation, solar power generation, electromagnetic wave shielding, visual display function, visual monitor function or visual screen function.

The contents of the following Japanese patent application(s) are incorporated herein by reference:

NO. 2019-230362 filed in JP on Dec. 20, 2019

NO. 2020-191007 filed in JP on Nov. 17, 2020

### BACKGROUND

### 1. Technical Field

The present invention relates to the imparting of functionality to windows, and in particular to a composite functional film internal window system in which functional glass films, sheets and panels, such as light-emitting films, light-dimming films, solar photovoltaic films, heat-generating films, heat-shielding and heat-insulating films, electromagnetic wave shielding films, visual displays, visual monitors or visual screens and so on are imparted to windows using an electrically conductive film holding frame without glass replacement or direct application to the glass.

In general, the windows of houses, buildings, and other structures are illuminated by installing transparent glass, but since ordinary glass does not functionally block light, it can be said that sunlight, including ultraviolet to infrared rays, is generally allowed to pass through. However, if light is collected without shielding from infrared rays, the indoor temperature rises too high in summer. In addition, direct exposure to ultraviolet rays can damage the skin or the like and deteriorate indoor items. There is also the problem of heat escaping from the indoor side through the glass windows in winter.

From the viewpoint of protecting against the harmful effects of such general glass collection, technologies for functional light shielding have been developed in recent years. In addition to curtains made of functional fabrics, installing shielding boards and so on, the most common method is to use functional films that block certain rays of light and attach them to the window glass.

In other words, it is a method of attaching functional films such as light-dimming film, heat shielding film, heat insulating film, ultraviolet UV shielding film, heat-generating film, solar photovoltaic film, and in addition, visual screens for special purposes to glass windows by limiting the wavelength of sunlight transmission.

In the description of the present invention, these functional films such as light-dimming film, heat shielding film, heat insulating film, ultraviolet UV shielding film, heat-generating film, solar photovoltaic film, electromagnetic wave shielding film and so on, as well as visual screens that serve special purposes and panels with the same functions are collectively referred to as “functional film sheets and panels”.

Various methods of using functional film sheets and panels without directly attaching them to window glass have also been devised and introduced in the literature. This will be described in the following Patent Documents 1 and 2.

For example, in Patent Document 1, a technical concept of the device and method is disclosed, wherein a sealed window or door with two effects of heat insulation and shading is realized by covering a frame (often made of wood) in the opening of a building (sash window, door and so on) with a resilient film (transparent or colored, as used in sun visors, file cases, —P-V-C, etc.), or by directly fixing a winding device or an extendable winding device, which is made of a film with cloth, paper, or other similar material fastened or laminated to a stick at the top or bottom, right or left, in a position that allows some space between it and the existing window glass or door, and moving the handle with the film with Velcro (registered trademark) attached thereto, up and down or left and right along the guide rails on the left and right or up and down, and if necessary, along the guide rails installed in between, fixing, with retractable Velcro (registered trademark) and so on, and attaching it to the frame opposite to the frame with the winder.

However, in this example, the function of the film is only specified as shading and heat insulation, and there is no detailed specification of the material, function and its effect. In addition, the method of attaching and fixing the film is technically inexperienced, and the tension of the film can be said to be not as high as that of a cloth curtain. In addition, the fixing method is simple, and there is no technology to avoid the danger of falling, making it largely impractical.

And in Patent Document 2, a rubber magnet is attached to the perimeter of the window main body via double-sided tape. Next, attach double-sided tape around the heat insulating material as well, and attach a rubber magnet on top of it. The technical concept of the window and frame, in which the heat insulating material made as described above is adsorbed to the main body through the force of a magnet, is disclosed.

However, even in this example, the technology is childish, such as attaching the heat insulating material via a magnet attached to the wall, and there is no description or mention of technology to avoid the danger of falling damage, and it must be said that the technology is greatly lacking in implementation requirements and practicality.

In addition, in the above-mentioned Patent Documents 1 and 2, the main purpose remains in the method of providing shading and heat insulation functions, and has not led to a window system that integrates more than one function. The technology of films, panels, and screens that function by energizing has also not yet been disclosed.

### 2. Related Art

### Prior Art Document

### Patent Document

Patent Document 1: Japanese Patent Application Publication No. 2003-74265
Patent Document 2: Japanese Patent Application Publication No. 2005-264701

### SUMMARY

### Object of the Invention

Since there are many issues that have not been resolved by the previous technologies or technical ideas as described above, it have not yet been achieved to install functional film sheets and panels on windows with special purposes or special functions such as light-dimming film, heat shielding film, heat insulating film, ultraviolet UV shielding film, heat-generating film, solar photovoltaic film, electromagnetic wave shielding film, and other functional film sheets and visual screens with special applications or special functions, as well as panels with the above functions.

In the past, in order to add the above functions to glass windows, one method was to replace the glass with functional glass in which functional film is laminated inside the glass, and the other method was to apply functional film sheets directly to the glass.

However, in the installation of functional glass and functional film sheets on window glass, there are issues regarding how to replace the functional glass and how to attach it directly to the glass, as described below. In other words, replacing existing glass with glass processed with light-dimming film, solar photovoltaic film, or visual screen requires significant cost and long construction period.

In addition, when light-dimming film, solar photovoltaic film, or visual screens are applied to glass, it is necessary to remove the existing film when renewing or removing each film, and the use of scrapers as removal tools may scratch the glass.

In rental buildings and houses, the film is applied at the expense of the tenant, and when the film is removed and the glass is damaged, the tenant is required by the landlord to replace the damaged glass, and thus bears the burden of compensation. In the case of landlord-ownership, it is the landlord's responsibility, and it goes without saying that the landlord does not like to bear the burden. The same problem exists when the film is renewed and removed, as the existing film needs to be removed.

Nowadays, existing glass may have glass shatterproof film attached to it. Assuming this, when applying light-dimming film, solar photovoltaic film, or visual screen to glass, it is necessary to remove the existing glass shatterproof film, and the same as above, there is a large possibility of damaging the existing glass. Applying light-dimming film, solar photovoltaic film, or visual screens to damaged glass may degrade the performance and durability of the various films. In addition, it may not be possible to attach it.

The present invention is intended to solve the problems of the conventional technology and to expand the market of functional film sheets and panels. It is aimed to ensure the safety of the main body glass window, and at the same time, demonstrate sufficiently various functions and usages of the functional film sheets and panels, and improve remarkably the workability of the installation of the glass window, and provide a film internal window system with composite functions such as light emission, light dimming, heat shielding, heat insulating, ultraviolet UV shielding, heat generation, solar power generation, electromagnetic wave shielding, visual display function, visual monitor function, or visual screen function and so on, which can significantly improve the workability of installation on glass windows and economic efficiency.

### Means for Solving Problems

To solve the problems, the composite functional film internal window system according to the present invention is characterized in being a window frame for holding film sheets and/or panels with functions of light emission, light dimming, heat shielding, heat insulating, ultraviolet UV shielding, heat generation, solar power generation, electromagnetic wave shielding, visual display function, visual monitor function or visual screen function or the like, as one single laminated layer, wherein the window frame is a window frame installed near an upper side and/or lower side and/or right side and/or left side of a glass window; and a laminating and holding structure of the window frame is a structure in which each of the film sheets and panels is separately sandwiched and fixed in place on a surface and held via insulating spacer sections between the upper side and/or lower side and/or right side and/or left side of a plurality of the film sheets and panels having the composite functions.

That is, the composite functional film internal window system according to the present invention is a frame of the internal window formed near the outer circumference of the four sides of a window whose window frame is of various shapes and sizes, and the frame is not limited to the four sides of the window that are connected in a square shape, but can be a frame that forms three or two sides of the window, or even one side.

Film sheets or panels with various functions are sandwiched between those internal window frame bodies via insulating spacers. The various functions refer to light emission, light dimming, heat shielding, heat insulating, ultraviolet UV shielding, heat generation, solar power generation, electromagnetic wave shielding, visual display function, visual monitor function or visual screen function and so on. These functional film sheets and panels are fixed in a state where in a well-tensioned state in four directions, three directions, two directions, or one direction, with the composite functional film internal window frame according to the present invention.

Then, the composite functional film internal window system according to the present invention is characterized in including a conductive terminal in the insulating spacer sections for holding the laminating and holding structure of the window frame in place on a surface, wherein each of the film sheets and the panels respectively has a conductive function with outside.

Some functional film sheets and panels require conductive functions, and the insulating spacers have conductive terminals to connect these conductive circuits to the outside. The invention does not limit the position, size, or material of forming the conductive terminals. The position, size, and material of these conductive terminals should be selected according to the optimal specifications of the functional film sheet and panel. Also, the number of layers of functional film sheets can also be freely set.

It is possible to hold an aspect wherein a circumferential section of the window frame has a gasket fixing structure made of flexible resin, and the gasket fixing structure is connected and fixed to a wall and/or wire and/or pigeonhole structure outside the window frame to maintain tension strength (tension) of the film sheets and panels.

In other words, the composite functional film internal window frame according to the present invention is only a frame, so it has a mechanism to be fixed to the window frame or wall of conventional installation near the glass window as described above. However, these fixing methods can be selected in a variety of ways within the scope of conventional technology, and the technical concept of the present invention encompasses these selection technologies.

In the composite functional film internal window system of the present invention, it can be an aspect wherein a structure of a corner section of the window frame is an L-shaped frame structure section, and a connecting section of the L-shaped frame structure section and the window frame are each fitted with an concavo-convex structure, and power terminals of the insulating spacer sections of the film sheets and the panels are each individually laminated inside the L-shaped frame structure section and electrically connected to the power terminals of the respective insulating spacer sections.

When the composite functional film internal window frame according to the present invention is shaped to connect the four sides of the frame, top, bottom, left and right, it goes without saying that the formation of the frame can be simplified by using an concavo-convex insert shape at the corner sections. It is also possible to have conductive terminals on each of the split frames.

It is possible to be an aspect wherein the composite functional film internal window system of the present invention can also take the condition wherein the upper side or lower side or right side or left side of the window frame is a film sheet and panel storage section where the film sheets and panels are wound and stored via spring force.

Since the functional film sheets and panels to be sandwiched in the composite functional film internal window system according to the present invention are often film-like and flexible, they can be wound and stored, and the film sheet storage section and panel storage section, which are wound and stored via spring force using conventional technology, allow for simple storage and movement.

In addition, it is possible to be an aspect wherein the composite functional film internal window system of the present invention can be a structure in which right and left sides of the window frame are connected and fixed to a support with casters at underfoot sections, and can be moved via the casters.

By coupling the support section with casters to the composite functional film internal window frame according to the present invention, the composite functional film internal window system according to the present invention can be easily moved from one glass window to the next glass window and from one room to the glass window of the next room. It will be possible to provide a composite functional glass window frame system that can be moved and installed as needed.

In addition, it can be a form with an additional function wherein the composite functional film internal window system of the present invention, comprising: a U-shaped upper receiving frame sandwiched in a manner that the window frame is sandwiched between the upper section of the window frame and the upper wall; a spring structure body sandwiched in a manner that the upper section of the window frame is depressed between the upper section of the window frame and the upper receiving frame; and a U-shaped lower receiving frame sandwiched in a manner that the window frame is sandwiched between the lower section of the window frame and the lower wall, wherein the window frame is held firmly without a gap in an up-down direction of the window frame. (Refer to FIG. 8 and FIG. 9.)

The above-mentioned U-shaped upper and lower receiving frames are a mechanism that sandwiches the main body (window frame) of the composite functional film internal window system according to the present invention from the upper and lower sides and secures it in the upper and lower walls, and the spring structure body provided in the upper receiving frame has the effect of pushing down the main body (window frame), so that it is fixed more firmly in the upper and lower walls. Spring structure body may use, for example, a plate spring or the like. The present invention does not limit the material of the spring structure body or an individual structure.

In other words, the above mechanism also has the function of shielding and preventing the air on the window side, which is the back side of the composite functional film internal window system according to the present invention, from flowing into the room, which is the front side of the same internal window system. Details are described in the detailed description of embodiments of the invention.

In addition, the above-mentioned U-shaped upper and lower receiving frames can be firmly fixed by simply inserting the main body (window frame) of the internal window system from top to bottom by installing the upper and lower receiving frames on the upper and lower walls first when installing the main body (window frame) of the composite functional film internal window system of the present invention, which has the effect of simplifying construction and greatly improving workability.

It can be an aspect where the composite functional film internal window system according to the present invention can also comprise a plurality of thin rectangular plate shaped gap sealing functional materials that are fixed through the receiving grooves formed in the upper and/or lower receiving frame, and cover the space between the left horizontal frame and the wall and the right horizontal frame and the wall of the window frame, sealing the gap in the left and right directions of the window frame and shielding the air movement in the back and front of the window frame. (Refer to FIG. 10 and FIG. 11.) Also, in the present invention, the term “gap sealing functional material” is used above, for example, rubber-based sealing material is one example. Herein, the material is not limited to “rubber”. Any material that has the so-called gap sealing function with elasticity, flexibility, surface adhesiveness and so on is acceptable. In the present invention, it is hereby specified that members with the gap sealing function are collectively described as “gap sealing functional materials” or “rubber-based sealing materials”.

A thin rectangular plate of gap sealing functional material, such as rubber-based sealing material, has the function of shielding the gap between the left and right walls of the main body (window frame) of the composite functional film internal window system according to the present invention. This function will also have the function of shielding and preventing air from the window side, which is the back side of the composite functional film internal window system, from flowing into the room, which is the front side of the same internal window system according to the present invention.

That is, the composite functional film internal window system according to the present invention is an internal window frame for holding the film sheets and/or panels with functions of light dimming, heat shielding, heat insulating, ultraviolet UV shielding, heat generation, solar power generation, electromagnetic wave shielding or visual screen function or the like, as one single laminated layer, and to maximize the above functions, it is extremely important to have a function of blocking and preventing the air of the window side, which is the back side, of the composite functional film internal window system according to the present invention, from flowing into the indoor, which is the front side, of the same internal window system, and shielding the window side, which is the back side, from the room side, which is the front side of the composite functional film internal window system according to the present invention, so that no gap exists between the two sides is an important technical element to maximize the above functions.

Note that the present invention is not limited to the embodiments described above, but can be implemented with various changes within the scope not deviating from the main purpose of the present invention. These are all one part of this technical concept.

### Effect of the Invention

The following effects occur according to the present invention.

1. Lower installation costs for functional film sheets and panels.

2. Lower renewal and removal costs of functional film sheets and panels.

3. Glass damage accidents caused by the installation of functional film sheets and panels can be prevented.

4. Functional film sheets and panels can be easily adopted, stimulating product demand.

5. Lower energy costs and reduced environmental impact through adoption of light-dimming film and solar photovoltaic film on existing glass can be realized.

6. The use of visual screen images for advertising will greatly contribute to corporate profits.

7. Projecting various types of information, market information, and meeting materials on the visual screen will greatly contribute to the improvement of productivity and corporate profits.

8. Relaxation and productivity can be expected to be improved from projecting nature and resort scenery on the visual screen.

According to the present invention, a composite functional film internal window system that is an internal window frame for holding film sheets and/or panels, with functions of light emission, light dimming, heat shielding, heat insulating, ultraviolet UV shielding, heat generation, solar power generation, electromagnetic wave shielding or the like, as a laminated single layer can be provided, and it is possible to provide a comfortable indoor environment by protecting and adjusting the environment inside the room from external harmful factors such as light, heat, ultraviolet UV rays, and electromagnetic waves.

That is, according to the present invention, the safety of the main body glass window can be ensured, and at the same time, various functions and usages of the functional film sheet are sufficiently demonstrated, and a film internal window with special purposes of visual display function, visual monitor function, or visual screen function or the like in addition to the functions such as light emission, light dimming, heat shielding, heat insulating, ultraviolet UV shielding, heat generation, solar power generation, electromagnetic wave shielding is realized to be provided, which can improve remarkably the workability of installation to the window and improve remarkably the economic efficiency.

### BRIEF DESCRIPTION OF THE DRAWINGS

FIG. 1 illustrates a schematic cross-sectional view showing a structural image of a composite functional film internal window system according to one embodiment of the present invention.

FIG. 2 illustrates a schematic diagram showing an overall image, as a longitudinal section, of the composite functional film internal window system according to one embodiment of the present invention.

FIG. 3 illustrates a schematic diagram showing an overall image of the composite functional film internal window system according to one embodiment of the present invention.

FIG. 4 illustrates a schematic diagram showing an image of a corner section of the composite functional film internal window system according to one embodiment of the present invention.

FIG. 5 illustrates a schematic cross-sectional view showing a structural image of the composite functional film internal window system according to one embodiment of the present invention.

FIG. 6 illustrates a schematic diagram showing an image of a winding body of the composite functional film internal window system according to one embodiment of the present invention.

FIG. 7 illustrates a schematic diagram showing an overall image of the composite functional film internal window system according to one embodiment of the present invention.

FIG. 8 illustrates a schematic diagram showing an image of a longitudinal section of upper and lower receiving frames of the composite functional film internal window system according to one embodiment of the present invention.

FIG. 9 illustrates a schematic diagram showing an image of an upper receiving frame of the composite functional film internal window system according to one embodiment of the present invention.

FIG. 10 illustrates a schematic diagram showing an image from above the composite functional film internal window system according to one embodiment of the present invention.

FIG. 11 illustrates a schematic diagram showing an image of a rubber-based sealing material that is a gap sealing functional material of the composite functional film internal window system according to one embodiment of the present invention.

### DETAILED DESCRIPTION OF EMBODIMENTS OF THE INVENTION

Hereinafter, the embodiments of the present invention are described with reference to the drawings. Note that in the following, the scope necessary for the explanation to achieve the purpose of the present invention will be shown schematically, and the scope necessary for the explanation of the relevant part of the invention will be mainly explained, and the parts omitted from the explanation will be based on known technology.

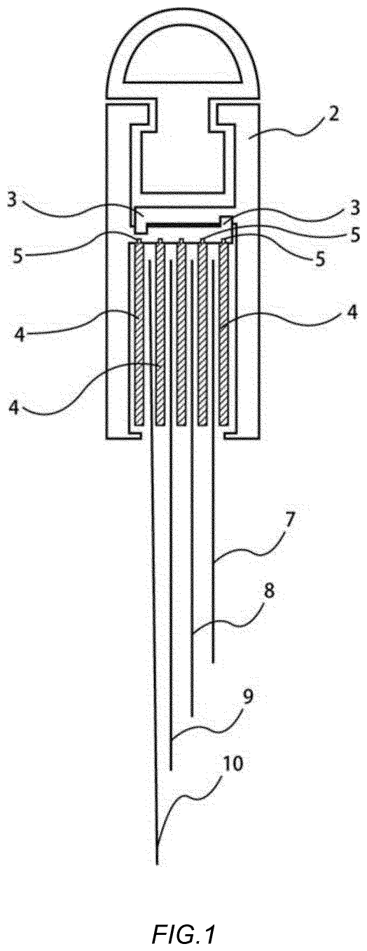

FIG. 1 illustrates a schematic cross-sectional view showing a structural image of a composite functional film internal window system according to one embodiment of the present invention. As shown in the same figure, the structure of the composite functional film internal window system mainly comprises a window frame body 2, a silicon gasket 6 and an insulating spacer section 4. FIG. 1 is a cross-sectional view of the window frame body 2, and a form wherein the window frame body 2 comprises a structure divided into a right side and a left side and is fitted together and fixed by the clinching section 3. The “window frame” described in the claims and the foregoing is also expressed as “window frame body” in the drawings and in the form for carrying out the invention in the same sense.

As shown in FIG. 1, in the window central side of this window frame body 2, the insulating spacer section 4 is configured by a plurality of layers in a thin sheet shape, with a structure where the end sections of a functional film sheet (for example, a solar photovoltaic film) 7, a functional film sheet (for example, an infrared reflective film) 8, a functional film sheet (for example, a light-dimming film) 9, a functional film sheet (for example, a graphic screen film) 10 and so on sandwiched and fixed between the respective insulating spacer sections 4. Then, the functional film sheet (for example, the solar photovoltaic film) 7, the functional film sheet (for example, the infrared reflective film) 8, the functional film sheet (for example, the light-dimming film) 9, the functional film sheet (for example, the graphic screen film) 10 are collectively referred to as “functional film sheet 7, 8, 9, 10”. When the clinching section 3 of the window frame body 2 is fitted and fixed, the respective functional film sheet 7, 8, 9, 10 are with a structure of being sandwiched and strongly fixed between the insulating spacer sections 4.

Each of the functional film sheet 7, 8, 9, 10 of the composite functional film internal window system according to one embodiment of the present invention may be a functional film sheet with functions such as light emission, light dimming, heat shielding, heat insulating, ultraviolet UV shielding, heat generation, solar power generation, electromagnetic wave shielding and so on, and may also additionally have special purposes such as visual display function, visual monitor function, or visual screen function and so on. Each functional film sheet may be selected according to usage and requirements.

Each end section of the insulating spacer section 4 may includes an internal conductive terminal section 5, and for example, when the functional film sheet is a film sheet that needs to have conductivity, connects the conductive function to the outside via the internal conductive terminal section 5. There is an electrical circuit installed via a conductive terminal or electrically conductive adhesive inside the window frame body 2, but it is omitted in FIG. 1. The insulating spacer sections 4 may be bonded together with electrically conductive resin or electrically conductive adhesive.

As shown in FIG. 1, the outer circumference side of the window frame body 2 of the composite functional film internal window system according to one embodiment of the present invention is with a structure wherein for example, a silicon gasket 6 is firmly attached to the window frame, and the window frame body 2 is fitted and fixed to the wall or beam (burr) near the window through the silicon gasket 6.

A part of the window frame body 2 is shown in the cross-sectional view in FIG. 1, the window frame body 2 of the composite functional film internal window system according to one embodiment of the present invention may be a square structure covering the entire window outline, or may be a horizontal long-handled bar on the upper and lower sides of the window. It may also be longitudinal bars on the right and left sides of the window. In addition, it may be one side of the window outer circumference frame.

The functional films 7, 8, 9, 10 of the composite functional film internal window system according to one embodiment of the present invention are characterized by being tensionally fixed without sagging and tensionally strong, respectively.

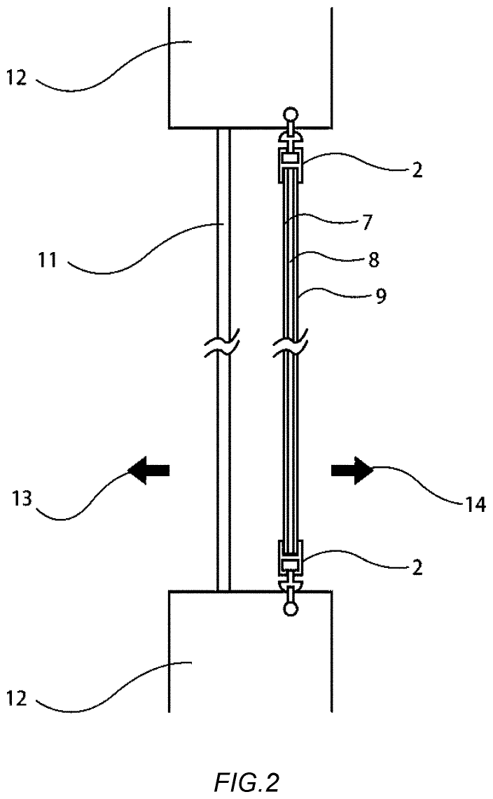

FIG. 2 illustrates a schematic diagram showing an overall image, as a longitudinal section, of the composite functional film internal window system according to one embodiment of the present invention. As shown in the same figure, the composite functional film internal window system according to one embodiment of the present invention is in a form fixed on the wall 12 and so on the indoor side of the window 11 and around the outer circumference of the window 11. However, the composite functional film internal window system according to one embodiment of the present invention also includes this case, as a technological concept, without excluding installation on the outdoor side of the window 11.

As shown in FIG. 2, a form is shown as one example where the composite functional film internal window system according to one embodiment of the present invention includes a window frame body 2 near the upper section and near the lower section of the window 11, and the functional films 7, 8, 9 and so on are installed to cover the window 11 in between. The silicon gasket 6 of the window frame body 2 is a coupling jig to fix the window frame body 2 on the wall 12. Anchors may not be unnecessary since the fitting method is based on silicon gaskets. The air layer between the window and the composite functional film internal window system according to one embodiment of the present invention becomes a sealed space, which also creates effects such as heat insulation, condensation prevention, and soundproofing and so on.

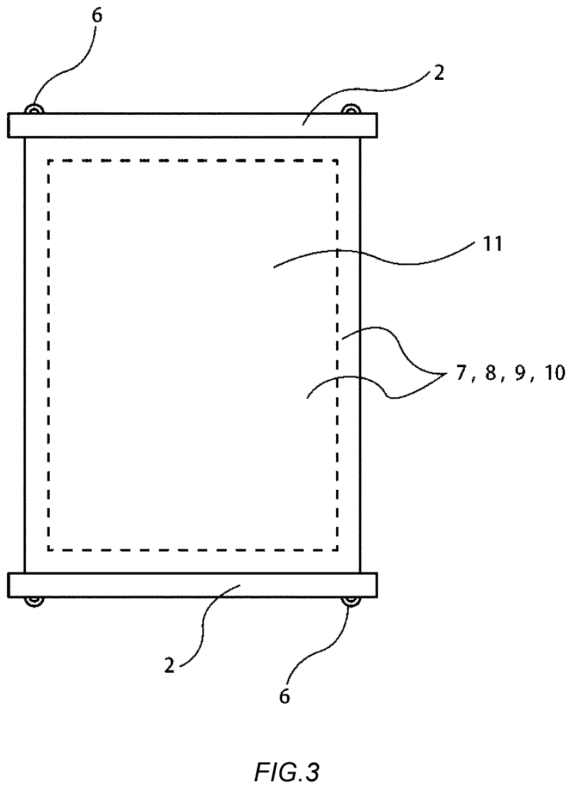

FIG. 3 illustrates a schematic diagram showing an overall image of the composite functional film internal window system according to one embodiment of the present invention. The composite functional film internal window system according to one embodiment of the present invention as shown in the same figure covers the glass window 11 (illustrated by dashed lines) and the functional films and panels perform their functions. The composite function refers to functions, selected as the film sheet or the panel, such as light emission, light dimming, heat shielding, heat insulating, ultraviolet UV shielding, heat generation, solar power generation, electromagnetic wave shielding, visual display function, visual monitor function or visual screen function and so on. In FIG. 3, four types of film sheets 7, 8, 9, 10 are shown, but the number, type, size, thickness and so on are not limited thereto, and may be selected according to requirements.

In FIG. 3, the window frame body 2 of the composite functional film internal window system according to one embodiment of the present invention is expressed in a form of being installed bi-directionally in the upper section and the lower section of the window. In this case, the film sheet can be strongly stretched downward by the weight of the window frame body 2 on the lower side. It has already been mentioned that the window frame body 2 can, of course, be a window frame body 2 that covers four directions or one direction.

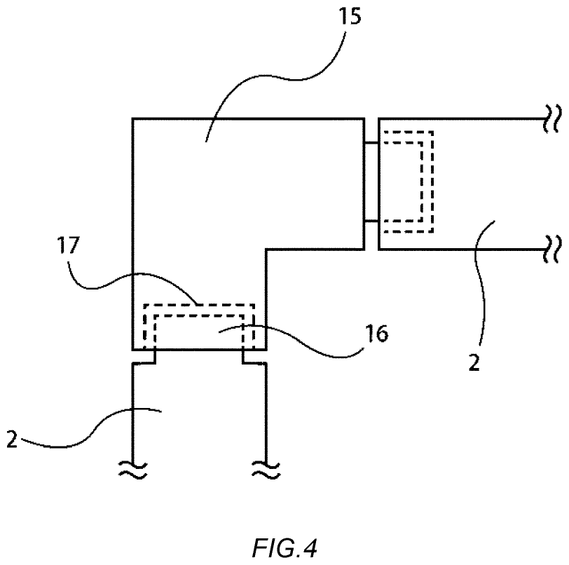

FIG. 4 illustrates a schematic diagram showing an image of a corner section of the composite functional film internal window system according to one embodiment of the present invention. As shown in the same figure, a case where the corner section of the composite functional film internal window system according to one embodiment of the present invention is shown to be an L-shaped window frame corner section 15.

The coupled structure with the coupled window frame body 2 becomes a structure fitted and coupled simply by the concave section 17 and the convex section 16 as shown in the same figure. However, the coupling section of the window frame body 2 in the present invention is not limited to the L-shaped window frame corner section 15. Various structures may be selected by the prior arts. These are included in the concept of the present invention.

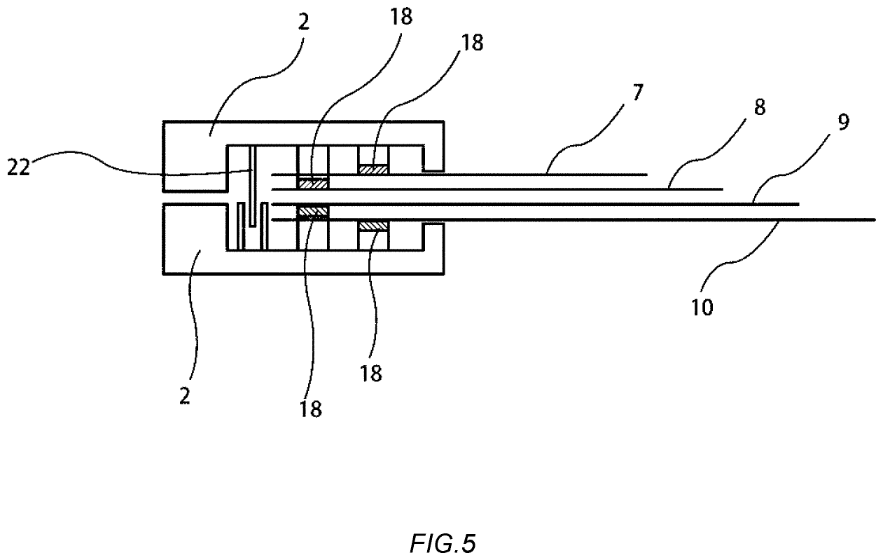

FIG. 5 illustrates a schematic cross-sectional view showing a structural image of the composite functional film internal window system according to one embodiment of the present invention. As shown in the same figure, it can be an aspect where the window frame body 2 of the composite functional glass window frame system according to one embodiment of the present invention can be divided into upper section and lower section as shown in the cross-sectional view, and the respective film sheets 7, 8, 9, 10 can be contacted and sandwiched by the protrusions having conductive terminal sections 18 at their edge sections. In FIG. 5, the insulating spacer sections 4 are omitted without being depicted.

As shown in FIG. 5, the upper section and the lower section of the window frame body 2 are mechanisms strongly coupled and fitted by the convex-concave fitting section 22. Also, the conductive circuit existing inside the window frame body 2 is omitted and not depicted in the figure, but it is obvious that it exists to ensure the function of power transmission to the outside.

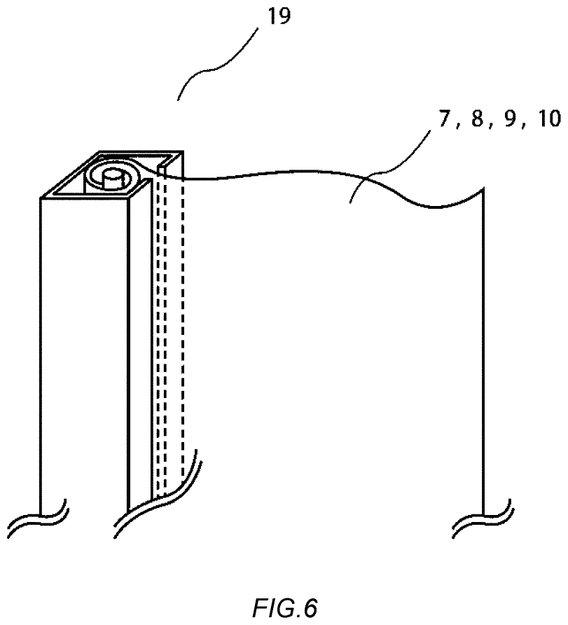

FIG. 6 illustrates a schematic diagram showing an image of the winding body of the composite functional film internal window system according to one embodiment of the present invention. As shown in the same figure, the window frame body 2 of a composite functional film internal window according to one embodiment of the present invention may be an automatic winding body 19. The functional film sheets 7, 8, 9, 10 are automatically wound and stored during storage by means of automatic winding tension using spring force, for example, using conventional technology. Installation and removal, as well as mobile installation, will be simplified.

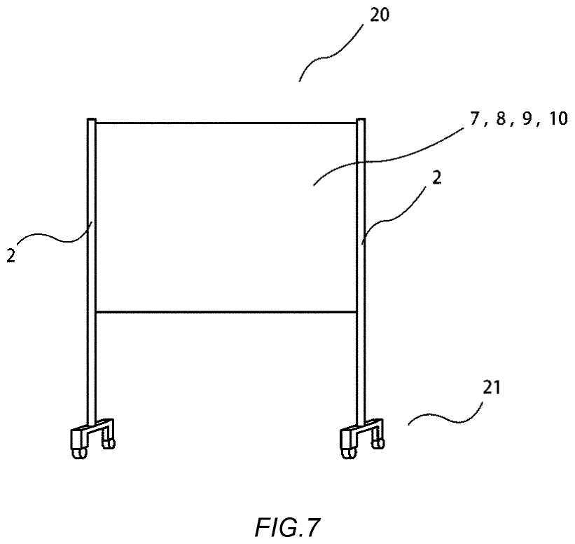

FIG. 7 illustrates a schematic diagram showing an overall image of the composite functional film internal window system according to one embodiment of the present invention. This shows a mobile 20 composite functional film internal window system. As shown in the same figure, the composite functional film internal window system according to one embodiment of the present invention can be moved from one window to the next window by using the window frame body 2 as the support section with casters 21. It can also be easily moved from one installation room to the next room's window. It will be possible to provide a composite functional film internal window system that can be moved and installed according to the requirements.

Also, the composite functional film internal window system according to one embodiment of the present invention may be in a form where its window frame body 2 combines both the automatic winding body 19 shown in FIG. 6 and the support with casters shown in FIG. 7.

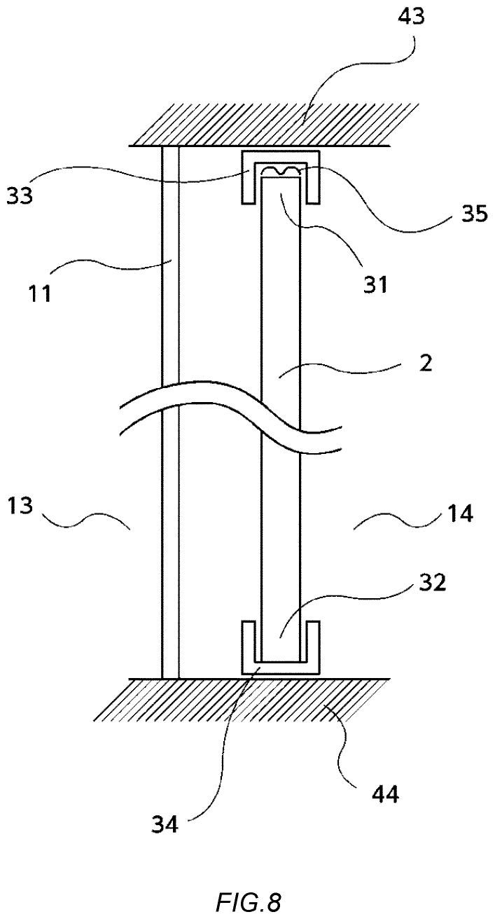

FIG. 8 illustrates a schematic diagram showing an image of the longitudinal section of the upper and lower receiving frames of the composite functional film internal window system according to one embodiment of the present invention. As shown in the same figure where the longitudinal section is illustrated, the window frame body 2 that is the main body of the composite functional film internal window system according to one embodiment of the present invention includes an approximately U-shaped upper receiving frame 33 in the upper section of the window frame body (upper frame) 31, being connected to the upper wall 43. The upper receiving frame 33 and the upper wall 43 are fixed by the bis 38 or the like. Herein, the fixing method is not limited to the bis.

As shown in FIG. 8, similarly, the window frame body 2 that is the main body of the composite functional film internal window system according to one embodiment of the present invention includes an approximately U-shaped lower receiving frame 34 in the lower section of the window frame body (lower frame) 32, being connected to the lower wall 44. The lower receiving frame 34 and the lower wall 44 may be fixed by the bis or the like, or may be not fixed by a screw or the like.

As shown in FIG. 8, between the window frame body (upper frame) 31 and the upper receiving frame 33, one of the spring structure bodies, the plate spring structure body 35, is interposed, and the plate spring structure body 35 has the function of pushing downward and fixing the window frame body (upper frame) 31. (The plate spring structure body 35 in FIG. 8 shows the concept as a simplified diagram.) By pushing downward the window frame body (upper frame) 31 by the plate spring structure body 35, the window frame body 2 of the composite functional film internal window system according to one embodiment of the present invention becomes to be with a structure, between the upper wall 43 and the lower wall 44, interposed between the upper receiving frame 33 and the lower receiving frame 34 in a close contact without a gap, and has a function of blocking the air flow on the window side of the main body (window frame body) 2 and in the indoor 14. Similarly, the composite functional film internal window system according to one embodiment of the present invention becomes to be with a structure firmly fixed between the upper wall 43 and the lower wall 44. The spring structure body shown in FIG. 8 is an example using the plate spring, but any spring structure that performs a similar function is sufficient, and the present invention is not limited to metal springs, but claims that any spring structure using plastic material, for example, is also included in the technological concept of the present invention.

That is, since the composite functional film internal window system according to one embodiment of the present invention is a window frame to hold film sheets and/or panels in a single laminated layer, which are with functions of light emission, light dimming, heat shielding, heat insulating, ultraviolet UV shielding, heat generation, solar power generation, electromagnetic wave shielding and so on, it is extremely important to have a function of blocking the air flows on the main body (window frame body) window side and in the indoor 14, so as to perform the above-mentioned functions. This function will be described later, but the same applies to the rubber-based sealing material that is the gap sealing functional material set on both the left and right sides of the main body (window frame body).

Also, since the composite functional film internal window system according to one embodiment of the present invention is with a structure where the main body (window frame body) 2 and the upper receiving frame 33 and the lower receiving frame 34 are shown as FIG. 8, when it is actually attached between the upper wall 43 and the lower wall 44 of the window section, a simple attaching method can demonstrate a large effect wherein the upper receiving frame 33 and the lower receiving frame 34 are attached first, and then, the main body (window frame body) 2 is pressed into the upper receiving frame 33 on the upper side, and the main body (window frame body) 2 is pressed into the lower receiving frame 34 on the lower side thereafter.

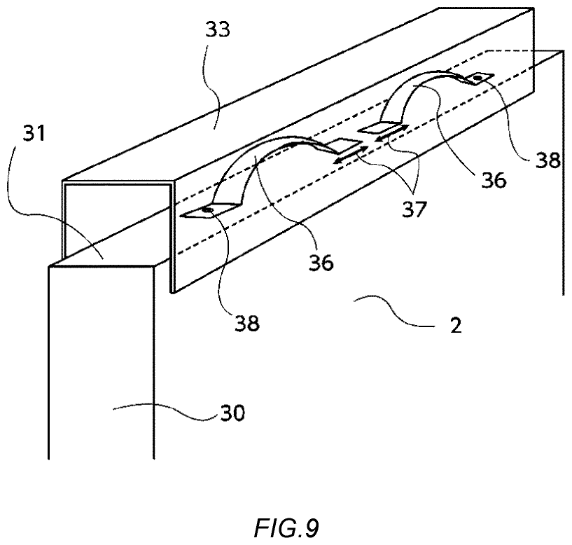

FIG. 9 illustrates a schematic diagram showing an image of the upper receiving frame of the composite functional film internal window system according to one embodiment of the present invention. As shown in the same figure, the upper receiving frame 33 is with a structure fixed by sandwiching the window frame body (upper frame) 31 of the window frame body 2 in an approximate U-shape. The plate spring structure body 35 in FIG. 8 is in a form as the plate spring 36 shown in FIG. 9, for example, since only a single side of the plate spring 36 is fixed to the window frame body (upper frame) 31 by the bis 38 or the like, it is depressed by the pressure of the upper receiving frame 33 from the upper side, becomes to be in an aspect deformed and moved as shown by the plate spring movement direction arrow 37. (The plate spring 36 in FIG. 9 is shown in solid lines instead of dashed lines for convenience of explanation.) The present invention does not limit the specific structure, number, strength or the like of the plate springs 36, and it goes without saying that any structure that effectively demonstrates the above functions is included in the technological concept of the present invention.

As shown in FIG. 9, with the structure of the above-mentioned upper receiving frame 33, plate spring 36, window frame body (upper frame) 31 and the upper wall 43 (as shown in FIG. 8), the window frame body (upper frame) 31 of the composite functional film internal window system according to one embodiment of the present invention is with a structure in a close contact with the upper wall 43. The upper receiving frame 33 and the upper wall 43 may be fixed by the bis or the like. Also, they may be fixed by magnet, adhesive, hook and loop fastener or the like. This is the same for the fixing method of the lower receiving frame 34 and the lower wall 44 (shown in FIG. 8).

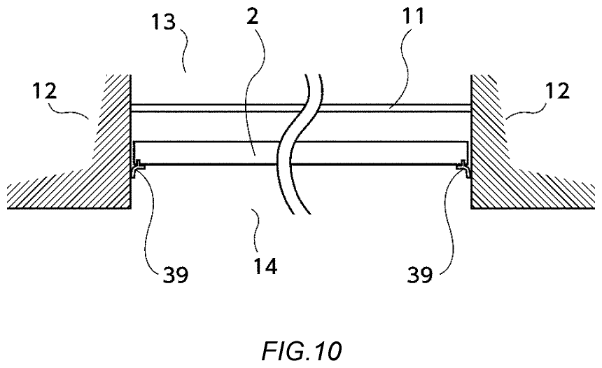

FIG. 10 illustrates a schematic diagram showing an image from the above of the composite functional film internal window system according to one embodiment of the present invention. As shown in the same figure, there is a form where the main body (window frame body) 2 of the composite functional film internal window system according to one embodiment of the present invention, when installed between the right and left walls 12, has a rubber-based sealing material 39, which is a gap sealing functional material covering the gap between the main body (window frame body) 2 and the right and left walls 12, installed therein.

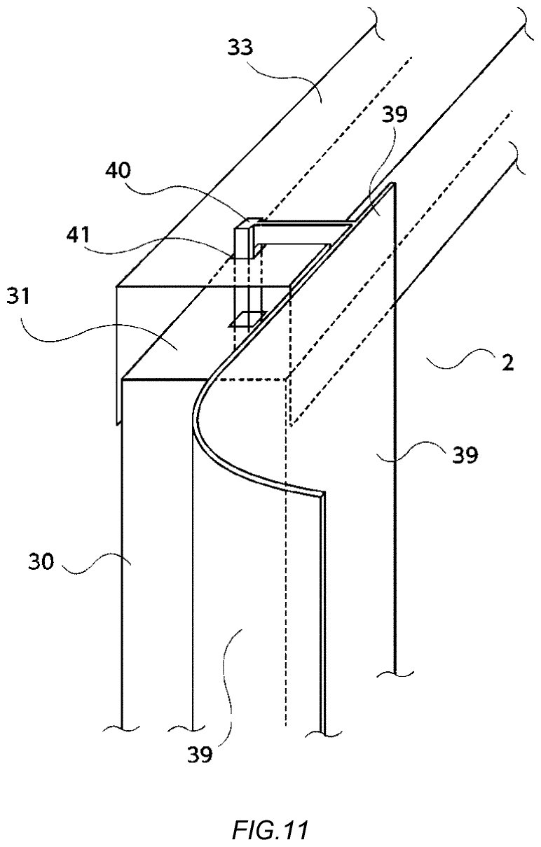

FIG. 11 illustrates a schematic diagram showing an image of the rubber-based sealing material that is a gap sealing functional material of the composite functional film internal window system according to one embodiment of the present invention. As shown in the same figure, there may be a form where the rubber-based sealing material 39 of the composite functional film internal window system according to one embodiment of the present invention has, for example, a rubber-based sealing material fixing section 40, and is fixed by being inserted and fitted in the rubber-based sealing material receiving section 41 provided in the upper frame of the main body (window frame body) 2.

Herein, the fixing method of the rubber-based sealing material that is the gap sealing functional material in the present invention is not limited to the form shown in FIG. 11. The material, size, thickness and shape of the rubber-based sealing material in the present invention are also not limited. As will be described later, the present invention claims the function of rubber-based sealing material as a gap sealing functional material as its technological concept. The material function to be demonstrated by a typical rubber-based sealing material with a gap sealing function is as long as it has a gap sealing (sealing) function such as elasticity, flexibility, surface adhesion or the like, and it is needless to say, the gap sealing functional material expressed in the present invention may be a synthetic resin material such as a silicon-based or fluorine-based material, for example.

The rubber-based sealing material that is the gap sealing functional material of the composite functional film internal window system according to one embodiment of the present invention is, for example, a thin rectangular-shaped plate that covers the window frame body (left and right horizontal frames) 30 of the main body (window frame body) 2 in a continuous manner from top to bottom, and is installed so that it covers the gap between the window frame body (left and right horizontal frames) 30 of the main body (window frame body) 2 and the left and right walls 12 and is in a close contact to them.

As shown in FIG. 10 and FIG. 11, the rubber-based sealing material 39 demonstrates the effect of blocking the air flows through the gap between the window 11 side and the indoor 14 side of the composite functional film internal window system according to one embodiment of the present invention by being in a close contact covering the gap from top to bottom continuously between the window frame body ((left and right horizontal frames) 30 and the right and left walls 12.

That is, just the same as the close contact fixing relationship of the upper wall 43 and the window frame body (upper frame) 31, the upper receiving frame 33 and the plate spring structure body 35, and the close contact fixing relationship of the lower wall 44 and lower receiving frame 34, and the window frame body (lower frame) 32 as already described in the description of FIG. 8 and FIG. 9, the rubber-based sealing material 39 blocks the air flows through the gap between the window 11 side and the indoor 14 side of the composite functional film internal window system according to one embodiment of the present invention, by being in close contact covering the gap between the window frame body ((left and right horizontal frames) 30 and the right and left walls 12 from top to bottom continuously.

To repeat, since the composite functional film internal window system according to one embodiment of the present invention is a window frame to hold film sheets and/or panels in a single laminated layer, which are with functions of light emission, light dimming, heat shielding, heat insulating, ultraviolet UV shielding, heat generation, solar power generation, electromagnetic wave shielding and so on, it is extremely important to have a function of sealing the gap and blocking the air flows between the main body (window frame body) window side, which is a back side, and in the indoor 14 side, which is a front side, and maximizing the above-mentioned functions, so as to perform the above-mentioned functions. Therefore, it is one technological concept of the present invention to have an above-mentioned structure for the purpose.

As described above, the present invention is not limited to the above-described embodiment, and various modifications can be made without departing from the gist of the present invention. All of these are part of this technical concept.

### INDUSTRIAL APPLICABILITY

As described above, according to the invention of the present application, the safety of the main body glass window can be ensured, and at the same time, various functions and usages of the functional film sheet are sufficiently demonstrated, and a film internal window with composite functions of visual display function, visual monitor function, or visual screen function or the like with special purposes in addition to the functions such as light emission, light dimming, heat shielding, heat insulating, ultraviolet UV shielding, heat generation, solar power generation is realized to be provided, which can improve remarkably the workability of installation to the window and improve remarkably the economic efficiency.

According to the invention of the present application, a composite functional film internal window system that is an internal window frame for holding film sheets and/or panels, with functions of light emission, light dimming, heat shielding, heat insulating, ultraviolet UV shielding, heat generation, solar power generation, electromagnetic wave shielding or the like, as a laminated single layer can be provided, and it is possible to provide a comfortable indoor environment by protecting and adjusting the environment inside the room from external harmful factors such as light, heat, ultraviolet UV rays, and electromagnetic waves.

Also, according to the present invention, a composite functional film internal window system that can significantly improve the safety and workability of the work of adding functionality to windows, while also significantly improving economic efficiency, will be realized.

And the invention is not limited to imparting of functionality to the windows of buildings, but can also be applied to the openings of vehicles such as trains, automobiles, and other structures such as greenhouses and vinyl houses. And it can be used and applied to all kinds of materials and applications. Therefore, the present application will be of great benefit to various industries.

### LIST OF REFERENCE NUMERALS

2: window frame body; 3: clinching section; 4: insulating spacer section; 5: internal conductive terminal section; 6: silicon gasket; 7: functional film sheet (for example, solar photovoltaic film); 8: functional film sheet (for example, infrared reflective film); 9: functional film sheet (for example, light-dimming film); 10: functional film sheet (for example, graphic screen film); 11: window; 12: wall; 13: outdoor; 14: indoor; 15: window frame corner section; 16: convex section; 17: concave section; 18: conductive terminal section; 19: automatic winding body; 20: mobile; 21: caster; 22: convex-concave fitting section; 30: window frame body ((left and right horizontal frames); 31: window frame body (upper frame); 32: window frame body (lower frame); 33: upper receiving frame; 34: lower receiving frame; 35: plate spring structure body; 36: plate spring; 37: plate spring movement direction arrow; 38: bis; 39: rubber-based sealing material (rubber-based sealing material that is gap sealing functional material); 40: rubber-based sealing material fixing section; 41: rubber-based sealing material receiving groove; 43: upper wall; 44: lower wall;

What is claimed is:

1. An internal window system, comprising:
a plurality of sheet members having difference functions; and
a window frame body for laminating and holding the plurality of sheet members.

2. The internal window system according to claim 1, wherein the plurality of sheet members have at least 2 different functions among light emission, light dimming, heat shielding, heat insulating, ultraviolet UV shielding, heat generation, solar power generation, electromagnetic wave shielding, visual display function, visual monitor function or visual screen function.

3. The internal window system according to claim 1, wherein the plurality of sheet members include a film sheet or a panel.

4. The internal window system according to claim 2, wherein the plurality of sheet members include a film sheet or a panel.

5. The internal window system according to claim 1, comprising an insulating spacer section, which is provided between the plurality of sheet members, to hold the plurality of sheet members in place on a surface.

6. The internal window system according to claim 2, comprising an insulating spacer section, which is provided between the plurality of sheet members, to hold the plurality of sheet members in place on a surface.

7. The internal window system according to claim 1, comprising a plurality of conductive terminal sections connected electrically to the plurality of sheet members.

8. The internal window system according to claim 2, comprising a plurality of conductive terminal sections connected electrically to the plurality of sheet members.

9. The internal window system according to claim 5, comprising a plurality of conductive terminal sections connected electrically to the plurality of sheet members.

10. The internal window system according to claim 1, comprising a gasket fixing structure made of flexible resin, provided in a circumferential section of the window frame body to couple with an external structure.

11. The internal window system according to claim 2, comprising a gasket fixing structure made of flexible resin, provided in a circumferential section of the window frame body to couple with an external structure.

12. The internal window system according to claim 1, comprising:
a plurality of window frame bodies for laminating and holding the plurality of sheet members; and
a L-shaped frame structure section for coupling the plurality of window frame bodies in a corner section of a window frame,
wherein the plurality of window frame bodies and the L-shaped frame structure sections are fitted by a concavo-convex structure.

13. The internal window system according to claim 2, comprising:
a plurality of window frame bodies for laminating and holding the plurality of sheet members; and
a L-shaped frame structure section for coupling the plurality of window frame bodies in a corner section of a window frame,
wherein the plurality of window frame bodies and the L-shaped frame structure sections are fitted by a concavo-convex structure.

14. The internal window system according to claim 1, comprising a storage section for winding and storing the plurality of sheet members.

15. The internal window system according to claim 2, comprising a storage section for winding and storing the plurality of sheet members.

16. The internal window system according to claim 1, comprising:
a support coupled and fixed to the window frame body; and
a caster, coupled to an underfoot section of the support, for moving the internal window system.

17. The internal window system according to claim 2, comprising:
a support coupled and fixed to the window frame body; and
a caster, coupled to an underfoot section of the support, for moving the internal window system.

18. The internal window system according to claim 1, comprising:
an upper receiving frame, which is U-shaped, for sandwiching an upper section of the window frame body;
a spring structure body provided between the upper receiving frame and the upper section of the window frame body; and
a lower receiving frame, which is U-shaped, for sandwiching a lower section of the window frame body.

19. The internal window system according to claim 2, comprising:
an upper receiving frame, which is U-shaped, for sandwiching an upper section of the window frame body;
a spring structure body, provided between the upper receiving frame and the upper section of the window frame body; and
a lower receiving frame, which is U-shaped, for sandwiching a lower section of the window frame body.

20. The internal window system according to claim 1, comprising a gap sealing functional material for sealing a gap between the window frame body and an external structure.
